(19) United States
(12) Patent Application Publication
(10) Pub. No.: US 2025/0009039 A1
(43) Pub. Date: Jan. 9, 2025

(54) AEROSOL-GENERATING DEVICE AND ASSOCIATED METHOD

(71) Applicant: Philip Morris Products S.A., Neuchatel (CH)

(72) Inventor: Michel BESSANT, Neuchatel (CH)

(73) Assignee: Philip Morris Products S.A., Neuchatel (CH)

(21) Appl. No.: 18/702,027

(22) PCT Filed: Oct. 27, 2021
(86) PCT No.: PCT/CN2021/126721

§ 371 Date: Apr. 17, 2024

(51) Int. Cl. A24F 40/53; G04F 1/00

(52) U.S. Cl. CPC A24F 40/53; G04F 1/005

(57) ABSTRACT

An aerosol-generating device configured to engage with and disengage from an aerosol-generating article, the aerosol-generating device including: an identifier including a light source to determine one or both of whether the article is engaged with the device and whether the article engaged with the device belongs to a first group of articles; a power supply configured to supply a current to the light source; a switch moveable between a closed position, in which the power supply is able to supply a current to the light source, and an open position, in which the power supply is unable to supply a current to the light source; and a chronometer coupled to the switch to move the switch from the closed to the open position if the current supplied or an indication of the current supplied exceeds a threshold for longer than a predetermined time period.

The present disclosure relates to an aerosol-generating device. The present disclosure also relates to a method of operating an aerosol-generating device.

An aerosol-generating system typically comprises an aerosol-generating device and an aerosol-generating article. In use, the aerosol-generating article is engaged with the aerosol-generating device, and a heater of the aerosol-generating system, for example, the device, heats an aerosol-forming substrate having an aerosol-former of the aerosol-generating article, so as to generate an aerosol. That generated aerosol may then be carried via an airflow path to a mouthpiece or air outlet of the device or article. The aerosol may be for inhalation by a user.

Some aerosol-generating devices comprise electrical components which are sensitive to high voltages or currents. In particular, some aerosol-generating devices comprise light sources and heaters which may be particularly sensitive to high voltages or currents. Light sources may be used to provide light to the aerosol-generating article, which, depending upon the presence or absence of marker such as a taggant in the aerosol-generating article, can function to identify a characteristic of the aerosol-generating article.

Typically, an aerosol-generating device comprises a controller which is configured to control the supply of power to the various electrical components of the device. In this way, the controller prevents excessive currents or voltages being supplied to the various electrical components of the device. It would be beneficial to provide an aerosol-generating device in which electrical components are protected from excessive currents or voltages in the event of a malfunction of the controller.

According to the present disclosure, there is provided an aerosol-generating device. The device may comprise an identifier. The identifier may be for determining one or both of whether an aerosol-generating article is engaged with the device and whether an aerosol-generating article engaged with the device belongs to a first group of articles. The identifier may comprise a light source. The device may comprise a power supply. The power supply may be for supplying a current to the light source. The device may comprise a switch. The switch may be moveable between a closed position and an open position. Optionally, when the switch is in the closed position, the power supply is able to supply a current to the light source. Optionally, when the switch is in the open position, the power supply is unable to supply a current to the light source. The device may comprise a chronometer. The chronometer may be coupled to the switch. The device may be configured to move the switch from the closed position to the open position if a current supplied to the light source, or an indication of a current supplied to the light source, exceeds a threshold for longer than a predetermined time period.

Thus, according to a first aspect of the present disclosure, there is provided an aerosol-generating device comprising an identifier for determining one or both of whether an aerosol-generating article is engaged with the device and whether an aerosol-generating article engaged with the device belongs to a first group of articles, the identifier comprising a light source; a power supply for supplying a current to the light source; a switch moveable between a closed position, in which the power supply is able to supply a current to the light source, and an open position, in which the power supply is unable to supply a current to the light source; and a chronometer coupled to the switch. The device is configured to move the switch from the closed position to the open position if a current supplied to the light source, or an indication of a current supplied to the light source, exceeds a threshold for longer than a predetermined time period.

Advantageously, movement of the switch from the closed position to the open position may protect the light source from excessive currents or voltage.

The indication of the current supplied to the light source may be, for example, a current measurement or estimate, or a voltage measurement or estimate, or a power usage measurement or estimate.

The chronometer may be a hardware chronometer. In this context, the term hardware chronometer may refer to a chronometer which is able to perform an operation, for example to open or close a switch, absent an instruction to do so from a controller.

The chronometer may be configured to move the switch from the closed position to the open position absent an instruction to do so from any separate controller if the current supplied to the light source, or the indication of the current supplied to the light source, exceeds the threshold for longer than the predetermined time period. Advantageously, this may allow protection of the light source even if a controller of the device malfunctions.

The device may comprise a controller for controlling a supply of current from the power supply to the light source. The identifier may be connected to, and optionally operated by, the controller. The chronometer may be configured to move the switch from the closed position to the open position absent an instruction to do so from the controller if the current supplied to the light source, or the indication of the current supplied to the light source, exceeds the threshold for longer than the predetermined time period. Advantageously, this may allow protection of the light source even if the controller malfunctions.

The chronometer may be activated by the controller. Once activated, the chronometer may function absent any further input from the controller. Once activated, the chronometer may be configured to move the switch from the closed position to the open position absent an instruction to do so from the controller, for example if the current supplied to the light source, or the indication of the current supplied to the light source, exceeds the threshold for longer than the predetermined time period.

The switch may be a high-side switch. The switch may electrically connect the power supply to the light source. The switch may be a low-side switch. The switch may electrically connect the light source to ground.

The device may comprise a second switch. The second switch may be a high-side switch. The second switch may electrically connect the power supply to the light source. The second switch may be a low-side switch. The second switch may electrically connect the light source to ground. Preferably, the switch is a high-side switch and the second switch is a low-side switch.

The chronometer may receive, for example directly receive, the indication of the current being supplied to the light source. The chronometer may be configured to move the switch from the closed position to the open position if the indication of the current supplied to the light source exceeds the threshold for longer than the predetermined time period.

The identifier may function as an article presence detector. That is, the identifier may be for determining, or configured to determine, whether an aerosol-generating article is engaged with the device. Alternatively, or in addition, the identifier may be for determining whether an aerosol-generating article engaged with the device belongs to a first group of articles.

The identifier may be for distinguishing, or configured to distinguish, between the first group of aerosol-generating articles for use with the device and a second group of aerosol-generating articles for use with the device.

The identifier may be connected to, and optionally operated by, the controller.

The light source may be a light emitting diode. The light source may be or comprise an infrared light source such as an infrared light emitting diode.

The identifier may comprise a light receiver. The light receiver may be or comprise a photodiode. The light receiver may be configured to receive light emitted by the light source. The light receiver may be configured to receive light reflected or emitted by an article engaged with the device. The light receiver may be connected to, and optionally operated by, the controller.

Determining whether an article is engaged with the device may comprise the light source illuminating an article engaged with the device. Determining whether an article is engaged with the device may comprise the light receiver receiving light reflected or emitted by an article engaged with the device. Determining whether an article is engaged with the device may comprise analysing the light received by the light receiver.

Determining whether an article engaged with the device belongs to the first group may comprise the light source illuminating an article engaged with the device. Determining whether an article engaged with the device belongs to the first group may comprise the light receiver receiving light reflected or emitted by an article engaged with the device. Determining whether an article engaged with the device belongs to the first group may comprise analysing the light received by the light receiver.

Aerosol-generating articles which belong to the first group of aerosol-generating articles may be referred to as genuine aerosol-generating articles. Aerosol-generating articles which do not belong to the first group of aerosol-generating articles may be referred to as non-genuine aerosol-generating articles. Ensuring that the aerosol-generating articles are genuine may serve to ensure the quality of the aerosol-generating article and the safety of the user.

The aerosol-generating device may be part of an aerosol-generating system. The aerosol-generating system may comprise the aerosol-generating device and an aerosol-generating article. The aerosol-generating article may be configured to engage with, and disengage from, the aerosol-generating device.

As used herein, the term “device” may refer to an aerosol-generating device. The term “article” may refer to an aerosol-generating article. The term “substrate” may refer to an aerosol-forming substrate.

The aerosol-generating system may comprise a heater, an aerosol-generating device and an aerosol-generating article.

The heater may comprise a heating element. References to heating the heater may be references to heating the heating element of the heater. The heating element may be configured to be heated to an operating temperature during use. The operating temperature may be at least 100 degrees Celsius. The operating temperature may be at least 200 degrees Celsius. The operating temperature may be at least 300 degrees Celsius.

The heater may comprise a means for heating the heating element. For example, the heater may comprise wiring configured to supply a current the heating element. Alternatively, or in addition, the heater may comprise an inductor such as an inductor coil configured to generate a fluctuating electromagnetic field and thereby heat a susceptor material of the heating element.

The heater may be an electrically resistive heater. The heating element may be configured to be electrically resistively heated.

The heater may be an inductive heater. The heating element may be configured to be inductively heated.

The heater may be an internal heater. That is, the heater or heating element may be configured to heat the aerosol-forming substrate of the aerosol-generating article from within the aerosol-forming substrate. For example, the aerosol-generating device may comprise the heater, and the heater may comprise a heating blade, pin or rod which penetrates an aerosol-forming substrate and is electrically resistively heated or inductively heated in use. The heating blade, pin or rod may be or comprise the heating element. Alternatively, the aerosol-generating article may comprise an inductively heatable heating element embedded in the aerosol-forming substrate of the article, and the aerosol-generating device may be configured to inductively heat the inductively heatable heating element in use, for example by using an inductor to generate a fluctuating electromagnetic field.

The heater may be an external heater. That is, the heater may be configured to heat the aerosol-forming substrate of the aerosol-generating article from outside the aerosol-forming substrate. For example, the aerosol-generating device may comprise the heater, and the heater may be arranged to encircle the aerosol-generating article to heat the aerosol-generating article. For example, the heater may comprise a substantially tubular heating element which surrounds a tube-shaped aerosol-forming substrate in use.

The heater may be for heating at least a portion of an aerosol-generating article, or an aerosol-forming substrate of the aerosol-generating article, releasably engaged with the aerosol-generating device.

The aerosol-generating device may comprise the heater. For example, the device may comprise a heating element in the form of pin, blade or rod. The heating element may be electrically connected to a power supply of the device. The heating element may be configured to penetrate an aerosol-forming substrate of an aerosol-generating article in use.

The aerosol-generating device may comprise a portion of the heater, for example the means for heating the heating element of the heater. The aerosol-generating article may comprise a portion of the heater, for example the heating element of the heater. For example, the aerosol-generating article may comprise an inductively heatable heating element embedded in the aerosol-forming substrate of the article, and the aerosol-generating device may comprise an inductor, such as an inductor coil, configured to generate a fluctuating electromagnetic field and inductively heat the inductively heatable heating element in use.

The aerosol-generating device may comprise a cavity. The device may comprise a housing. The housing may define the cavity. The housing may be configured to be held in use. The cavity may be for receiving at least a portion of the aerosol-generating article. Engaging the article with the device may be or comprise receiving at least a portion of the article in the cavity of the device. The heating element of the device may extend longitudinally in the cavity, for example from a base of a chamber defining the cavity. The heating element may be configured to penetrate the aerosol-forming substrate of the article when the article is received in the cavity.

The system, for example the device, may comprise an air inlet. For example, the housing of the device may define the air inlet. An air flow path may be formed from the air inlet to the cavity of the device. The system, for example the article, may comprise an air outlet. For example, a mouthpiece of the article may comprise the air outlet. In use, an air flow path may be defined between the air inlet and the air outlet. For example, in use, a user may inhale on an article received in a cavity of the device, and this inhalation may cause air to flow through the air inlet of the device, then into the cavity of the device, then through the article engaged with the device, then out through the air outlet of the mouthpiece of the article, and then into the mouth of the user.

The article of the system may belong to the first group of articles. The article may comprise an aerosol-forming substrate. The aerosol-forming substrate may be a solid aerosol-forming substrate. The aerosol-forming substrate may be a gel. The aerosol-forming substrate may be a liquid.

As used herein, the term “aerosol-forming substrate” may refer to a substrate capable of releasing volatile compounds that can form an aerosol. The volatile compounds may be released by heating or combusting the aerosol-forming substrate.

The aerosol-forming substrate may comprise nicotine. The aerosol-forming substrate may comprise plant-based material. The aerosol-forming substrate may comprise homogenised plant-based material. The aerosol-forming substrate may comprise tobacco. The aerosol-forming substrate may comprise a tobacco-containing material. The tobacco-containing material may contain volatile tobacco flavour compounds. These compounds may be released from the aerosol-forming substrate upon heating. The aerosol-forming substrate may comprise homogenised tobacco material. The aerosol-forming substrate may comprise other additives and ingredients, such as flavourants. The liquid aerosol-forming substrate may comprise one or more of water, solvents, ethanol, plant extracts and natural or artificial flavours. The aerosol-forming substrate may comprise an aerosol former. Examples of suitable aerosol formers are glycerine, glycerol, and propylene glycol.

The aerosol-generating article may comprise a hollow tubular element. The aerosol-generating article may comprise an aerosol cooling element. The aerosol-generating article may comprise a mouthpiece. The aerosol-generating article may comprise an outer wrapper, for example a paper wrapper.

The aerosol-generating article may comprise an aerosol-forming substrate, a hollow tubular element, an aerosol cooling element and a mouthpiece arranged sequentially in co-axial alignment and circumscribed by an outer wrapper.

In use, an article may be engaged with the device, for example received in the cavity of the device. As the article is received in the cavity, a heating element, for example in the form of a heating blade extending longitudinally from a base of the cavity, may penetrate an aerosol-forming substrate of the article. A user may then inhale on a mouthpiece of the article. This may cause air to flow through the air inlet of the device. This air flow may be detected by a puff detection mechanism of the device. This may cause operation of the heating element.

Alternatively, the heater may be manually activated by a user, for example using a button. The heating element may then heat up. This may heat up the aerosol-forming substrate of the article such that volatile compounds are released by the aerosol-forming substrate. The user inhalation may cause the air flow through the air inlet to then flow through the aerosol-forming substrate. The volatile compounds released by the aerosol-forming substrate may be entrained in the air flow. The air and entrained compounds may then flow through the hollow tubular element, and the aerosol cooling element. During this time, the volatile compounds may cool and condense to form an aerosol. The aerosol may then flow through the mouthpiece of the article and into the mouth of the user.

As would be understood by the skilled person after reading this disclosure, the above paragraph describes use of a particular system, but other systems may implement the invention.

The power supply may be for supplying power to the heating element, for example to one or both of the means for heating the heating element and the heating element. The power supply may be for supplying power to any or all of the components of the device which require power. The power supply may comprise one or more power units. Different power units may be for supplying power to different components.

The device may comprise a controller. The controller may be connected to any or all of the electrical components of the device. As would be understood by the skilled person after reading this disclosure, the controller may control operation of the various components of the device. The controller may control a supply of power, for example from the power supply, to the any or all components of the device which require power.

The first group of aerosol-generating articles may comprise or consist of aerosol-generating articles configured, or in some way designed or optimised, for use with the aerosol-generating device. The first group of aerosol-generating articles may comprise or consist of aerosol-generating articles having one or more particular brands, one or more particular types or compositions of aerosol-forming substrate, a particular date of production, a particular range of dates of production, a particular batch number, a particular range of batch numbers, a particular use-by date, or a particular range of use-by dates.

Prior to engaging an aerosol-generating article with the aerosol-generating device, the aerosol-generating device may be in an idle state.

The method may comprise, or may be performed following, engagement of an aerosol-generating article with the aerosol-generating device.

Engaging the article with the device may comprise or consist of receiving at least a portion of the article within the cavity.

The method may comprise activating the device, for example using a user interface such as a button on the device. This step may move the device from the idle state to an active state. This step may occur after engaging an aerosol-generating article with the aerosol-generating device. The transition from the idle state to the active state may cause electrical perturbations, for example voltage fluctuations across the electrical components of the device.

The identifier may be configured to detect a presence of an aerosol-generating article engaged with the aerosol-generating device, for example received in the cavity of the device. The method may comprise a presence determining step of determining whether an aerosol-generating article is engaged with the aerosol-generating device. Optionally, the method may comprise determining whether the article engaged with the device belongs to the first group of articles only if the presence determining step determines that an aerosol-generating article is engaged with the aerosol-generating device. The presence determining step may be triggered by, or carried out automatically after, moving the device from the idle state to the active state.

The identifier may be particularly sensitive to electrical perturbations, for example voltage fluctuations. For example, the light source of the identifier may be particularly sensitive to electrical perturbations. In particular, the light source as described with respect to the first aspect may be particularly sensitive to electrical perturbations.

In particular, the light source may have a continuous forward current of between 2 and 100 milliamperes. For example, the light source may have a continuous forward current of between 10 and 50 milliamperes. For example, the light source may have a continuous forward current of around 20 milliamperes. In this context, the continuous forward current may refer to a maximum current that can be supplied to the light source continuously without the light source being damaged or without a serious risk of the light source being damaged. In other words, where the continuous forward current is around 20 milliamperes, supplying the light source with more or significantly more than 20 milliamperes continuously, that is for an extended period of time, for example several seconds or minutes, may damage or likely damage the light source.

In addition, the light source may have a peak forward current of between 0.1 and 10 ampere. Or the light source may have a peak forward current of between 0.5 and 5 ampere. Or the light source may have a peak forward current of around 1 ampere. A corresponding limiting time may be between 1 microsecond and 10 milliseconds. A corresponding limiting time may be between 10 microseconds and 1 millisecond. In this context, the peak forward current and corresponding limiting time may refer to a maximum current that can be supplied to the light source for the limiting time without the light source being damaged or without a serious risk of the light source being damaged. In other words, where the peak forward current is around 1 ampere and the corresponding limiting time is 1 millisecond, supplying the light source with 1 or more amperes for more than 1 millisecond may damage or likely damage the light source.

The controller, or software such as firmware of the controller, may control the current supplied to the light source in use. This may prevent a damaging current being supplied to the light source.

As discussed above, the aerosol-generating device may comprise a high-side switch. The high-side switch may be connected to, and optionally operated by, the controller. Advantageously, the high-side switch may help to protect the light source should there be an issue with the controller, for example a software bug. The high-side switch may thus help to mitigate against the sensitivity of the light source to electrical perturbations.

The power supply of the device may be for supplying power to the light source. The high-side switch may be located between the power supply and the light source. The high-side switch may be configured to electrically connect or electrically disconnect the power supply to the light source.

The high-side switch may be moveable between an open position and a closed position. When the high-side switch is in the open position, the light source may not be electrically connected to the power supply. When the high-side switch is in the open position, the electrical circuit comprising the high-side switch and the light source may be broken. The power supply may be unable to supply power to the light source when the high-side switch is in the open position. When the high-side switch is in the closed position, the light source may be electrically connected to the power supply. When the high-side switch is in the open position, the electrical circuit comprising the high-side switch and the light source may be complete or unbroken. The power supply may be able to supply power to the light source when the high-side switch is in the closed position.

Herein, enabling or closing a switch such as the high-side switch may refer to moving the switch from the open position to the closed position. Disabling or opening a switch may refer to moving the switch from the closed position to the open position.

The high-side switch may comprise or be coupled to a chronometer, for example the chronometer discussed above with respect to the first aspect. The chronometer may comprise a timer.

The chronometer may be connected to, and optionally operated by, the controller. The high-side switch may be connected to, and optionally operated by, the chronometer.

The chronometer may be a hardware chronometer. Thus, the chronometer may be able to open, close, or both open and close the high-side switch absent an instruction to do so from a controller. This is explained in more detail below.

The chronometer may be configured to determine a time period over which the light source has been continuously supplied with a current, or with a current greater than a threshold. The chronometer may initiate timing, or start the time period, when a current supplied to the light source is above a threshold. The chronometer may end timing, or end or reset the time period, when a current supplied to the light source falls to or below a second threshold. The threshold and the second threshold may be equal or different. One or both of the threshold and the second threshold may be zero amperes. One or both of the threshold and the second threshold may be may be equal to or within 50 percent of the peak forward current of the light source. One or both of the threshold and the second threshold may be at least 0.1 or 0.5 amperes. One or both of the threshold and the second threshold may be no more than 10 or 5 amperes. One or both of the threshold and the second threshold may be between 0.1 and 10 amperes, or between 0.5 and 5 amperes, or around 1 ampere.

When the time period reaches a predetermined time period, the high-side switch may move from the closed position to the open position. For example, when the time period reaches a predetermined time period, the controller or the chronometer may cause the high-side switch to open. Opening the high-side switch may break the electrical connection between the power supply and the light source, and may stop the flow of current to the light source. Advantageously, this may protect the light source.

Preferably, the chronometer is a hardware chronometer and causes the high-side switch to open absent an instruction to do so from the controller. Advantageously, this may mean that the high-side switch may be opened to protect the light source even if the controller malfunctions.

The predetermined time period may be based on the limiting time of the light source. The predetermined time period may be greater than, or at least 1.1, 2, 5, or 10 times, the limiting time of the light source. The predetermined time period may be at least 1, 10, 100, or 1,000 microseconds. The predetermined time period may be no more than 10, 5, or 1 milliseconds. The predetermined time period may be between 1 microsecond and 10 milliseconds. The predetermined time period may be between 10 microseconds and 1 millisecond.

The aerosol-generating device may comprise a low-side switch. For example, as mentioned above, the switch or the second switch may be a low-side switch. The low-side switch may be connected to, and optionally operated by, the controller. Advantageously, the low-side switch may help to protect the light source should there be an issue with the controller, for example a software bug. The low-side switch may thus help to mitigate against the sensitivity of the light source to electrical perturbations.

The low-side switch may be configured to electrically connect the light source to ground. As used herein, the term ground may be used to refer to an electrical ground.

The low-side switch may be moveable between an open position and a closed position. When the low-side switch is in the open position, the light source may not be electrically connected to ground. When the low-side switch is in the open position, the electrical circuit comprising the low-side switch and the light source may be broken. The power supply may be unable to supply power to the light source when the low-side switch is in the open position. When the low-side switch is in the closed position, the light source may be electrically connected to ground. When the low-side switch is in the open position, the electrical circuit comprising the low-side switch and the light source may be complete or unbroken. The power supply may be able to supply power to the light source when the low-side switch is in the closed position.

The low-side switch may comprise or be coupled to the chronometer. The low-side switch may be coupled to the high-side switch. The low-side switch may be coupled to, and optionally operated by, the controller. The low-side switch may be coupled to, and optionally operated by, the chronometer.

When the time period reaches a predetermined time period, the low-side switch may move from the closed position to the open position. For example, when the time period reaches a predetermined time period, the controller or the chronometer may cause the low-side switch to open.

Where the device comprises both the high-side switch and the low-side switch, when the time period reaches a predetermined time period, both the high-side switch and the low-side switch may move from the closed position to the open position. Advantageously, this may provide even further protection for the light source from excessive currents. This is because, even if there is a fault with one of the high-side switch and the low-side switch, the other may be able to stop an excessive current flowing through the light source.

The method may comprise enabling the high-side switch. This may comprise moving the high-side switch from the open position to the closed position. This may be done when the device is moved from the idle state to the active state, or afterwards. This may be triggered by, or done automatically, after the device is moved from the idle state to the active state. When the device is in the idle state, the high-side switch may be disabled.

The method may comprise enabling the low-side switch. This may comprise moving the low-side switch from the open position to the closed position. This may be done when the device is moved from the idle state to the active state, or afterwards. This may be triggered by, or done automatically, after the device is moved from the idle state to the active state. When the device is in the idle state, the low-side switch may be disabled.

The method may comprise enabling the power supply. This may be done when the device is moved from the idle state to the active state, or afterwards. This may be triggered by, or done automatically, after the device is moved from the idle state to the active state. This may be done before or after enabling one or both of the high-side switch and the low-side switch.

Following enabling of the power supply, electrical perturbations such as voltage fluctuations may be present in the electrical components of the device.

The method may comprise allowing a time period for electronics stabilisation. This may be triggered by, or occur automatically after, enabling the power supply. The device may prevent further use of the device, for example heating of the heater or operation of the light source, during this time period. A compromise must be made when setting this time period; there is a minimum length of time which the electronics need to stabilise but, if the time period is too long, this could annoy the user. The time period for stabilisation may be at least 5, 10, 50, 100, 500, 1,000, or 5,000 microseconds. The time period for stabilisation may be no more than 500, 100 or 75 milliseconds. The time period for stabilisation may be between 5 microseconds and 500 milliseconds. The time period for stabilisation may be r between 100 microseconds and 100 milliseconds. The time period for stabilisation may be between 5 and 100 milliseconds.

The method may comprise detecting the presence of the aerosol-generating article engaged with the aerosol-generating device, for example received in the cavity of the device. That is, the method may comprise determining whether or not an aerosol-generating article is engaged with the aerosol-generating device, for example received in the cavity of the device. This step may occur after, for example may be triggered by or occur automatically after, allowing the time period for electronics stabilisation. This step may comprise supplying the light source with a current, for example from the power supply. This current may be at least 1, 2 or 10 milliamperes. Alternatively, or in addition, this current may be no more than 200, 100, or 50 milliamperes. The current may preferably be around 20 milliamperes. This current may be supplied for at least 100, 500, 1,000, 5,000 or 10,000 nanoseconds. This current may be supplied for no more than 2, 1, 0.5, or 0.1, 0.05, or 0.02 seconds. The current may preferably be supplied for between 100 nanoseconds and 2 seconds, or between 10 microseconds and 2 milliseconds.

Light emitted by the light source may reflect off the article and be received by the light receiver. This may allow the identifier to detect the presence of the article.

If the identifier detects the presence of an article (i.e. determines that an article is engaged with the device), then a first determining step of determining whether or not the aerosol-generating article engaged with the aerosol-generating device belongs to the first group of aerosol-generating articles may be carried out. The first determining step may be triggered by, or occur automatically following, the detection of the presence of the article. Optionally, the first determining step is carried out only if the identifier detects the presence of an article (i.e. determines that an article is engaged with the device). The first determining step may be carried out by the identifier. Specifically, the light source, for example the infrared light emitting diode, may illuminate the article engaged with the device. The light receiver, for example photodiode, may then receive light reflected or emitted by the article. Based on the light received by the light receiver, the identifier may be able to determine whether or not the article engaged with the device belongs to the first group of articles.

The first group of articles may comprise a plurality of sub-groups. One or both of the first determining step and the second determining step may comprise determining which, if any, of the plurality of sub-groups the aerosol-generating article engaged with the aerosol-generating device belongs to. This may be done in the same way as determining whether the article belongs to the first group. For example, this may be done based on the light received by the light receiver after being reflected or emitted by the article.

If the identifier detects no presence of an article (i.e. determines that no article is engaged with the device), then the first determining step of determining whether or not an aerosol-generating article engaged with the aerosol-generating device belongs to the first group of aerosol-generating articles may not be carried out. The identifier detecting no presence of an article (i.e. determining that no article is engaged with the device) may cause the device to return to the idle state.

The article of the system may be an article belonging to the first group of articles. The article of the system, or each article of the first group of articles, may comprise a marker. Articles in different sub-groups of the first group may comprise different markers.

Any suitable form of marker may be used. The marker may be detectable by the identifier. The identifier may use the marker of the article to determine whether or not the article belongs to the first group. The identifier may use the marker of the article to determine which sub-group, if any, of the first group the article belongs to.

Any suitable marker may be used. The marker may comprise a visual indicator such as a barcode.

The marker may comprise a taggant. The article may comprise at least one component incorporating the taggant within a material of the at least one component. The taggant may comprise an identifiable spectroscopic signature. The use of the taggant incorporated within the material of a component of the article may advantageously prevent the taggant from being removed from the component after manufacture. In this way, the tamper resistance, and difficulty of counterfeiting, of the aerosol-generating article may be improved.

The taggant may be incorporated into any component of the aerosol-generating article, including but not limited to: paper, such as wrapper paper; filters; tipping papers; tobacco; tobacco wraps; coatings; binders; fixations; glues; inks, foams, hollow acetate tubes; wraps; and lacquers. The taggant may be incorporated into the component by either adding it during the manufacture of the material, for example by adding it to a paper slurry or paste before drying, or by painting or spraying it onto the component. Typically, the taggant is incorporated into the component in trace, nano-gram, quantities. For example, where the taggant is sprayed on the surface, the solution being sprayed may incorporate the taggant in a concentration of between 1 ppm and 1000 ppm.

To enable the taggant to be identified more accurately, the taggant may comprise an identifiable spectroscopic signature in absorption. When the taggant is illuminated by the light source or light source of the identifier, the taggant may absorb a specific wavelength, or set of wavelengths, and the wavelengths of light subsequently received by the light receiver or light sensor of the identifier may therefore enable the identifier to determine the taggant in dependence on the absent wavelengths. This information may then be used to determine whether or not the article belongs to the first group of articles.

The physical and chemical structure of the taggant can be controlled such that the absorbed wavelength of light can be set as required. In a preferred embodiment, the absorbed wavelength of light is not in the visible spectrum. Preferably, the absorbed wavelength(s) is or are in one or both of the infrared and ultraviolet range.

In addition, or instead of the taggant comprising an identifiable spectroscopic signature in absorption, the taggant may comprise an identifiable spectroscopic signature in emission. When the taggant is illuminated by the light source or light source, the light preferably excites the taggant and the taggant emits at least one wavelength of light shifted from the wavelength of the illuminating light. As will be appreciated, this is a form of photoluminescence, and may be phosphorescence, or fluorescence. By controlling the physical and chemical structure of the taggant the spectroscopic signature can be controlled. In some embodiments, the identifiable signature may depend on the time response of the emission in relation to the excitation, or the decay rate of the emission after excitation.

In a preferred embodiment, the wavelength of the light emitted by the taggant is not in the visible spectrum. Preferably, the wavelength(s) of the light emitted by the taggant is or are in one or both of the infrared and ultraviolet range.

In a preferred embodiment, the taggant is distributed throughout the material. By distributing the taggant throughout the material, the orientation of the aerosol-generating article within the aerosol-generating device may not be important. This enables the use of the system to be simpler for the user. In addition, by distributing the taggant throughout the material, the tamper resistance of the article may be improved because it may be more difficult to completely remove the taggant. In a particularly preferred embodiment, the taggant is substantially homogeneously distributed throughout the material.

Different articles belonging to the first group may comprise different taggants, or different combinations of taggants. These taggants or combinations of taggants may have different and identifiable spectroscopic signatures. This may allow the identifier to distinguish between different types of articles, or sub-groups, belonging to the first group and operate accordingly.

The taggant is preferably stable at elevated temperatures of up to 1,500 degrees Celsius. As used herein, the term stable may refer to the taggant having a consistent spectroscopic signature, and to the taggant not decomposing. By providing a taggant which remains stable at elevated temperatures, standard manufacturing processes may be used when manufacturing the aerosol-generating article.

The material of the aerosol-generating component incorporating the taggant may be manufactured by adding the taggant as an ingredient in the slurries used to make the material. The slurries may then be formed, for example by casting, and dried to produce the material, such as paper or wrapper material.

The taggant may be configured such that at normal operating temperature of the aerosol-generating article the taggant is deactivated. As used herein, deactivated may refer to the taggant no longer having the identifiable spectroscopic signature. In use, the temperature required to generate an aerosol may be greater than the temperature required to deactivate the taggant. In this way, the aerosol-generating device can determine whether the aerosol-generating article has been used previously, and operate accordingly. For example, if the taggant is deactivated, the first determining step may determine that the article does not belong to the first group of articles. As such, an article in the first group of articles may no longer be in the first group of articles after use. The temperature range of the aerosol-generating article components during normal operation is preferably between about 50 degrees Celsius and about 300 degrees Celsius depending on the location and type of component of the aerosol-generating device. As such, preferably the taggant is deactivated at a temperature between about 50 degrees Celsius and about 500 degrees Celsius. More preferably, the taggant is deactivated at a temperature between about 70 degrees Celsius and about 100 degrees Celsius.

The taggant may be deactivated by decomposing at the above described elevated temperatures such that it no longer has the identifiable spectroscopic signature. Alternatively, the taggant may be deactivated by being masked by an additional, temperature-dependent additive. The additional additive may become opaque at the elevated temperature, or may change colour to mask the taggant's signature.

Similarly to the above description of the taggant being stable at elevated temperatures, the taggant is preferably chemically stable. Preferably, the taggant is sufficiently chemically stable so as not to decompose during manufacture of the material or the component. Thus, the taggant is preferably stable when it is: exposed to liquid water; exposed to water vapour; exposed to other commonly used solvents; upon drying; upon physical deformation of the material to form the component; upon exposure to increased temperatures; and upon exposure to reduced temperatures. As such, during the above described material manufacturing process, the taggant does not decompose and the taggant maintains the identifiable spectroscopic signature.

The taggant is preferably in powder form. Taggant powder advantageously enables the taggant to be incorporated into the material more easily. Preferably, the taggant is a powder composed of at least one of: a rare earth; an actinide metal oxide; a ceramic. The rare earth is preferably a lanthanide.

The marker or identifiable spectroscopic signature of the taggant may be associated with one or more of the aerosol-generating article type, the aerosol-forming substrate type, the date of production, the place of production, the batch number, other production details, and the use-by-date.

The first determining step may comprise supplying a current to the light source, for example from the power supply. This current may be at least 100, 200, 500 or 800 milliamperes. Alternatively, or in addition, this current may be no more than 2,000 or 1,000 milliamperes. The current may preferably be between 500 and 2,000 or between 800 and 1,000 milliamperes. This current may be supplied for at least 20, 50, 100, or 200 microseconds. This current may be supplied for no more than 20, 10, 5 or 2 milliseconds. The current may preferably be supplied for between 20 microseconds and 10 milliseconds. The current may preferably be supplied for between 20 microseconds and 2 milliseconds.

The aerosol-generating device may comprise a heater high-side switch. The heater high-side switch may be connected to, and optionally operated by, the controller. Advantageously, the heater high-side switch may help to prevent an excessively large current being passed through the heater for an excessively long time period. The heater high-side switch functions in a similar manner to the high-side switch described earlier, which is used to protect the light source.

The power supply may be for supplying power to the heater. The heater high-side switch may be located between the power supply and the heater. The heater high-side switch may be configured to electrically connect the power supply to the heater. When the device is in the idle state, the heater high-side switch may be disabled.

Operation of the heater high-side switch may be similar to operation of the high-side switch. The heater high-side switch may be moveable between an open position and a closed position. When the heater high-side switch is in the open position, the heater may not be electrically connected to the power supply. That is, the power supply may be unable to supply power to the heater when the heater high-side switch is in the open position. When the heater high-side switch is in the closed position, the heater may be electrically connected to the power supply. That is, the power supply may be able to supply power to the heater when the heater high-side switch is in the closed position.

The heater high-side switch may comprise or be coupled to a heater chronometer. The heater chronometer may be connected to, and optionally operated by, the controller. The heater high-side switch may be connected to, and optionally operated by, the chronometer.

The heater chronometer may be a hardware chronometer. Thus, the heater chronometer may be able to operate the heater high-side switch absent an instruction to do so from a controller.

The heater chronometer may be configured to determine a heater time period over which the heater has been continuously supplied with a current, or with a current greater than a heater threshold. The heater chronometer may initiate timing, or start the heater time period, when a current supplied to the heater is above a heater threshold. The heater chronometer may end timing, or end or reset the heater time period, when a current supplied to the heater falls below a second heater threshold. The heater threshold and the second heater threshold may be equal or different.

When the heater time period reaches a predetermined heater time period, the heater high-side switch may move from the closed position to the open position. For example, when the heater time period reaches the heater predetermined time period, the controller or the heater chronometer may cause the heater high-side switch to open.

Preferably, the heater chronometer is a hardware chronometer and causes the heater high-side switch to open absent an instruction to do so from the controller. Advantageously, this may mean that the heater high-side switch may be opened to protect the heater even if the controller malfunctions.

The aerosol-generating device may comprise a heater low-side switch. The heater low-side switch may be connected to, and optionally operated by, the controller. When the device is in the idle state, the heater low-side switch may be disabled.

The heater low-side switch may be configured to electrically connect the heater to ground.

Operation of the heater low-side switch may be similar to operation of the low-side switch. The heater low-side switch may be moveable between an open position and a closed position. When the heater low-side switch is in the open position, the heater may not be electrically connected to ground. When the heater low-side switch is in the open position, the electrical circuit comprising the heater low-side switch and the heater may be broken. The power supply may be unable to supply power to the heater when the heater low-side switch is in the open position. When the heater low-side switch is in the closed position, the heater may be electrically connected to ground. When the heater low-side switch is in the open position, the electrical circuit comprising the heater low-side switch and the heater may be complete or unbroken. The power supply may be able to supply power to the heater when the heater low-side switch is in the closed position.

The heater low-side switch may comprise or be coupled to the heater chronometer. The heater low-side switch may be coupled to, and optionally operated by, the controller. The heater low-side switch may be coupled to, and optionally operated by, the heater chronometer.

When the heater time period reaches a heater predetermined time period, the heater low-side switch may move from the closed position to the open position. For example, when the heater time period reaches the heater predetermined time period, the controller or the heater chronometer may cause the heater low-side switch to open.

Preferably, the chronometer is a hardware chronometer and causes the low-side switch to open absent an instruction to do so from the controller. Advantageously, this may mean that the heater low-side switch may be opened to protect the heater even if the controller malfunctions.

Thus, when the heater time period reaches a heater predetermined time period, both the heater high-side switch and the heater low-side switch may move from the closed position to the open position. This may provide even further protection for the heater from excessive currents.

The method may comprise enabling the heater high-side switch. This may comprise moving the heater high-side switch from the open position to the closed position. This may be done when the device is moved from the idle state to the active state, or afterwards, for example after detecting the presence of an article or after the first determining step. This may be triggered by, or done automatically after, movement of the device from the idle state to the active state or detection of the presence of an article or the first determining step.

The method may comprise enabling the low-side switch. This may comprise moving the heater low-side switch from the open position to the closed position. This may be done when the device is moved from the idle state to the active state, or afterwards, for example after detecting the presence of an article or after the first determining step. This may be triggered by, or done automatically after, movement of the device from the idle state to the active state or detection of the presence of an article or the first determining step.

The method may comprise pre-heating the heater, for example after the first determining step or after enabling one or both of the heater high-side switch and the heater low-side switch. This may be referred to as the pre-heating step. Optionally, the pre-heating step begins only if the first determining step determines that the article engaged with the device belongs to the first group of articles. The pre-heating step may be triggered by, or begin automatically after, the first determining step determining that the article engaged with the device belongs to the first group.

If the first determining step determines that the aerosol-generating article engaged with the aerosol-generating device does not belong to the first group of aerosol-generating articles, the method may comprise preventing beginning the step of pre-heating the heater until the first determining step is repeated and determines that the aerosol-generating article engaged with the aerosol-generating device does belong to the first group of aerosol-generating articles. If the first determining step determines that the aerosol-generating article engaged with the aerosol-generating device does not belong to the first group of aerosol-generating articles, this may cause the device to return to the idle state.

The pre-heating step may comprise supplying current to the heater, for example from the power supply. For example, the pre-heating step may comprise supplying current to an electrically resistive heating element to cause the heating element to heat up, or an alternating current to an inductor so as to generate a fluctuating magnetic field which causes a susceptor material in a heating element to heat up. This step may comprise raising a temperature of the heater, or a heating element of the heater, to an operational temperature. This step may comprise raising a temperature of the heater, or a heating element of the heater, to a temperature of at least 100, 200, or 300 degrees Celsius, for example from room temperature.

The whole step of pre-heating the heater, from beginning to end, may take at least 5, 10 or 20 seconds. The whole step of pre-heating the heater, from beginning to end, may take no more than 100, 60, 50, 40, or 30 seconds. The whole step of pre-heating the heater, from beginning to end, may take between 10 and 60 seconds. The whole step of pre-heating the heater, from beginning to end, may take between 20 and 40 seconds.

The step of pre-heating the heater may be considered to have begun once a current is supplied to the heater. The step of pre-heating the heater may be considered to have begun once a current above a particular threshold has been supplied to the heater. The step of pre-heating the heater may be considered to have begun once the heater or heating element has reached a particular temperature.

The pre-heating step may be dependent on the sub-group to which the article engaged with the device belongs or dependent on the sub-group determined by the first determining step. The pre-heating step may be different for articles belonging to different sub-groups. For example, the temperature profile of the heater or heating element during the pre-heating step may be different for different sub-groups. This may be controlled by the current sent to the heater. For example, the device may be configured to heat the heater or heating element to different peak temperatures for different sub-groups during the pre-heating step. A particular pre-heating step may be performed, for example selected from a plurality of pre-set pre-heating steps, based on the sub-group of the article, for example the sub-group determined by the first determining step. Advantageously, this may allow the pre-heating step to be tailored to the article engaged with the device.

The method may comprise a pre-heating check step. The pre-heating check step may comprise determining whether or not the pre-heating step has finished. The step of pre-heating the heater may be considered to have finished once the heater or heating element has reached a certain temperature. The pre-heating check step may be triggered by, or occur automatically after, beginning the pre-heater of the heater. The pre-heating check step may take place repeatedly, for example at regular intervals.

The device may be configured to indicate to a user, for example using one or more of a visual, audible, or tactile indication that the pre-heating step has finished.

The method may comprise a second determining step of determining whether or not the aerosol-generating article engaged with the aerosol-generating device belongs to the first group of aerosol-generating articles. The second determining step may be separate to the first determining step. The second determining step may occur after the first determining step. The second determining step may be carried out by the identifier. Specifically, the light source, for example the infrared light emitting diode, may illuminate the article engaged with the device. The light receiver, for example the photodiode, may then receive light returned from the article. Based on the light received by the light receiver, the identifier may be able to determine whether or not the article engaged with the device belongs to the first group of articles, or to a particular sub-group of the first group of articles.

If the second determining step determines that the aerosol-generating article belongs to the first group of aerosol-generating articles, a main heating step may be performed. The main heating step may be triggered by, or occur automatically following, the second determining step determining that the aerosol-generating article belongs to the first group of aerosol-generating articles. During the main heating step, at least a portion of the aerosol-generating article may be heated so as to form an aerosol. The average temperature of the heater or heating element may be higher during the main heating step than during the pre-heating step.

The second determining step may occur a predetermined time after beginning or finishing the pre-heating step. The second determining step may begin or occur during the pre-heating step. The second determining step may begin or occur after the pre-heating step. The second determining step may be triggered by completion of the pre-heating step.

Advantageously, the second determining step may prevent a user from using a genuine article to allow beginning of the pre-heating of the heater, and then replacing the genuine article with a non-genuine article.

The second determining step may comprise determining which of the plurality of sub-groups of the first group the article engaged with the device belongs to. The second determining step may comprise determining whether or not the article engaged with the device belongs to the same sub-group as the sub-group determined during the first determining step. This step may be carried out by the identifier. Specifically, the light source, for example the infrared light emitting diode, may illuminate the article engaged with the device. The light receiver, for example the photodiode, may then receive light from the article. Based on the light received by the light receiver, the identifier may be able to determine which sub-group of the first group the article engaged with the device belongs to.

If, and optionally only if, the sub-group determined in the second determining step is the same as determined in the first determining step, use of the device may be continued. For example, a main heating step may be triggered or allowed. If the sub-group determined in the second determining step is not the same as determined in the first determining step, the device may not allow further use. For example, a main heating step may not be allowed. If the sub-group determined in the second determining step is not the same as determined in the first determining step, this may cause the device to return to the idle state.

Advantageously, this may prevent the user replacing a first type of genuine article with a second type of genuine article. This may prevent, for example, a heating regime optimised for the first type of genuine article being used to heat the second type of genuine article.

The main heating step may comprise heating the aerosol-generating article so as to generate an aerosol, for example for inhalation by a user. The main heating step may occur after the step of pre-heating the heater has finished. The main heating step may occur after the second determining step. The main heating step may be triggered by, or occur automatically after, the second determining step determines that the article engaged with the device belongs to the first group.

The main heating step may be dependent on the sub-group to which the article engaged with the device belongs or dependent on the sub-group determined by the first or second determining step. The main heating step may be different for articles belonging to different sub-groups. For example, the temperature profile of the heater or heating element during the main heating step may be different for different sub-groups. This may be controlled by the current sent to the heater. For example, the device may be configured to heat the heater or heating element to different peak temperatures for different sub-groups during the main heating step. A particular main heating step may be performed, for example selected from a plurality of pre-set main heating steps, based on the sub-group of the article, for example the sub-group determined by the first or second determining step. Advantageously, this may allow the main heating step to be tailored to the article engaged with the device.

The method may comprise disabling the high-side switch. The high-side switch may be disabled after the second determining step, for example after the main heating step. Disabling the high-side switch may be triggered by, or occur automatically after, the main heating step is completed.

The method may comprise disabling the low-side switch. The low-side switch may be disabled after the second determining step, for example after the main heating step. Disabling the low-side switch may be triggered by, or occur automatically after, the main heating step is completed.

The method may comprise disabling the heater high-side switch. The heater high-side switch may be disabled after the main heating step. Disabling the heater high-side switch may be triggered by, or occur automatically after, the main heating step is completed.

The method may comprise disabling the heater low-side switch. The heater low-side switch may be disabled after the main heating step. Disabling the heater low-side switch may be triggered by, or occur automatically after, the main heating step is completed.

The method may comprise disabling the power supply. The power supply may be disabled after the second determining step, for example after the main heating step, for example after disabling one or more of the high-side switch, the low-side switch, the heater high-side switch, and the heater low-side switch. Disabling the power supply may be triggered by, or occur automatically after, the main heating step is completed.

The method may comprise returning the device to the idle state. This may occur as the power supply is disabled or before or after the power supply is disabled. Returning the device to the idle state may be triggered by, or occur automatically after, the main heating step is completed.

The device may comprise a user interface. The user interface may be operable to return the device from the active state to the idle state. The user interface may be operable to return the device from the active state to the idle state at any point. The user interface may be operable to return the device from the active state to the idle state during the pre-heating step or during the main heating step.

The user interface may comprise a button. Use of the button, for example pressing the button for longer than a predetermined time period, may allow or cause the device to return from the active state to the idle state, for example during pre-heating or the main heating step. This predetermined time period may be at least 0.5, 1 or 1.5 seconds.

Features described in relation to the first aspect may be applicable to the second aspect. For example, any features described in relation to the device of the first aspect, such as the identifier, heater, power supply, controller, or any of the switches of the device of the first aspect, may be applicable to the second aspect.

Features described in relation to the second aspect may also be applicable to the first aspect. For example, features described as method steps of the second aspect may be applicable to the device of the first aspect. The device, or a controller of the device, of the first aspect may be configured to carry out method steps of the second aspect.

As used herein, the term “aerosol” may refer to a dispersion of solid particles, or liquid droplets, or a combination of solid particles and liquid droplets, in a gas. The aerosol may be visible or invisible. The aerosol may include vapours of substances that are ordinarily liquid or solid at room temperature as well as solid particles, or liquid droplets, or a combination of solid particles and liquid droplets.

The invention is defined in the claims. However, below there is provided a non-exhaustive list of non-limiting examples. Any one or more of the features of these examples may be combined with any one or more features of another example, embodiment, or aspect described herein.
Example Ex1. An aerosol-generating device comprising:
an identifier for determining one or both of whether an aerosol-generating article is engaged with the device and whether an aerosol-generating article engaged with the device belongs to a first group of articles, the identifier comprising a light source;
a power supply for supplying a current to the light source;
a switch moveable between a closed position, in which the power supply is able to supply a current to the light source, and an open position, in which the power supply is unable to supply a current to the light source; and
a chronometer coupled to the switch,
wherein the device, for example the chronometer of the device, is configured to move the switch from the closed position to the open position if a current supplied to the light source, or an indication of a current supplied to the light source, exceeds a threshold for longer than a predetermined time period.
Example Ex2. An aerosol-generating device according to Example Ex1, wherein the chronometer is a hardware chronometer and is configured to move the switch from the closed position to the open position absent an instruction to do so from any separate controller if the current supplied to the light source, or the indication of the current supplied to the light source, exceeds the threshold for longer than the predetermined time period.
Example Ex3. An aerosol-generating device according to Example Ex1, wherein the device comprises a controller for controlling a supply of current from the power supply to the light source.
Example Ex4. An aerosol-generating device according to Example Ex3, wherein the chronometer is a hardware chronometer and is configured to move the switch from the closed position to the open position absent an instruction to do so from the controller if the current supplied to the light source, or the indication of the current supplied to the light source, exceeds the threshold for longer than the predetermined time period.
Example Ex5. An aerosol-generating device according to any preceding claim, wherein the switch is a high-side switch and electrically connects the power supply to the light source.
Example Ex6. An aerosol-generating device according to any of Examples Ex1 to Ex4, wherein the switch is a low-side switch and electrically connects the light source to ground.
Example Ex7. An aerosol-generating device according to Example Ex5, wherein the device comprises a second switch which is a low-side switch which electrically connects the light source to ground.
Example Ex8. An aerosol-generating device according to Example Ex7, wherein the chronometer receives the indication of the current being supplied to the light source, and wherein the chronometer is configured to move the switch from the closed position to the open position if the indication of the current supplied to the light source exceeds the threshold for longer than the predetermined time period.
Example Ex9. An aerosol-generating device according to any preceding example, wherein the identifier comprises a light receiver for receiving light reflected or emitted by an article engaged with the device and illuminated by light from the light source.
Example Ex10. An aerosol-generating device according to example Ex9, wherein the light receiver is a photodiode.
Example Ex11. An aerosol-generating device according to example Ex9 or Ex10, wherein the device is configured to analyse the light received by the light receiver to determine whether the article engaged with the device belongs to the first group of articles.
Example Ex12. An aerosol-generating device according to any preceding example, wherein the light source is a light emitting diode.
Example Ex13. An aerosol-generating device according to Example Ex12, wherein the light source is an infrared light emitting diode.
Example Ex14. An aerosol-generating device according to any preceding example, wherein the predetermined time period is at least 1 microsecond.
Example Ex15. An aerosol-generating device according to any preceding example, wherein the predetermined time period is no more than 10 milliseconds.
Example Ex16. An aerosol-generating device according to any preceding example, wherein the threshold is zero amperes.
Example Ex17. A method of operating an aerosol-generating device, the aerosol-generating device being a device according to any preceding example, and the method comprising:
moving the switch from the closed position to the open position if a current supplied to the light source, or an indication of a current supplied to the light source, exceeds a threshold for longer than a predetermined time period.

Examples will now be further described with reference to the figures in which:

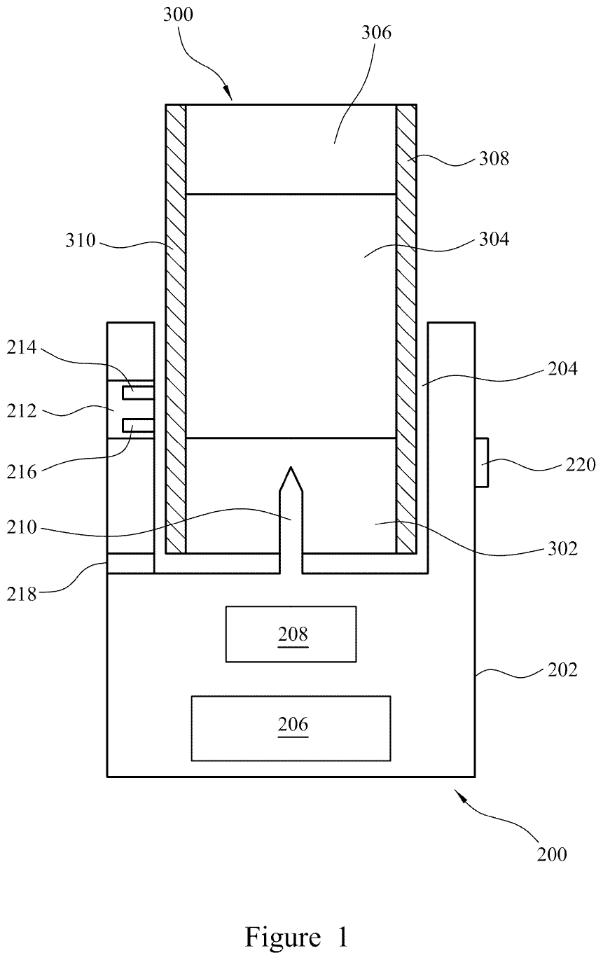

FIG. 1 shows an aerosol-generating system;

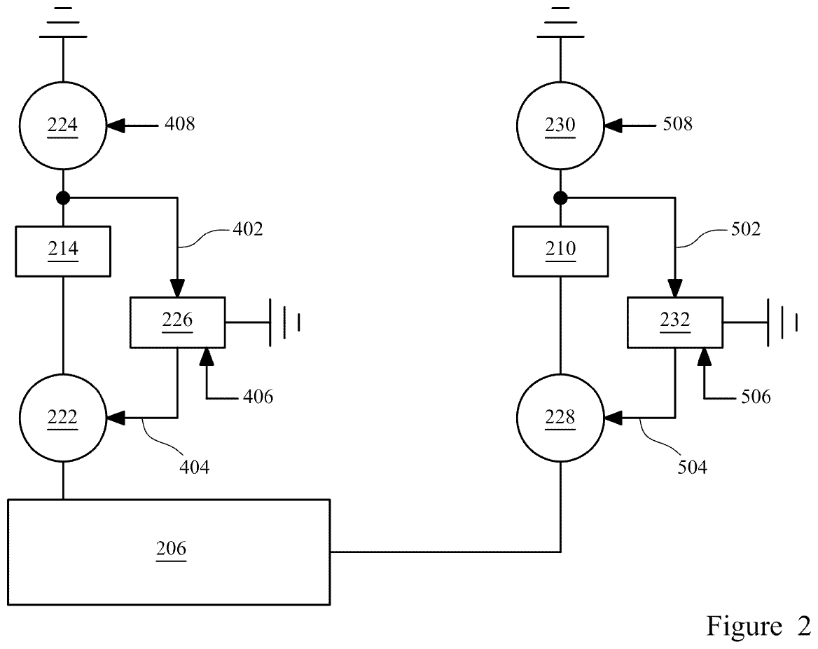

FIG. 2 shows circuitry of the aerosol-generating system of FIG. 1; and

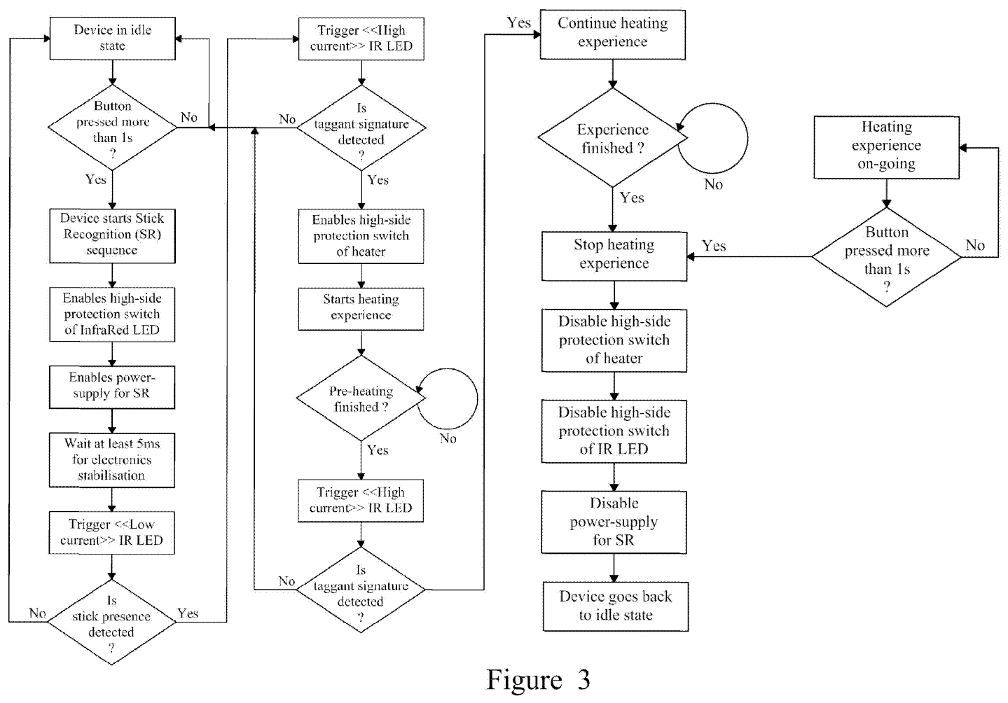

FIG. 3 shows a flow diagram showing a method of operating the aerosol-generating system of FIG. 1.

FIG. 1 shows an aerosol-generating system 100. The system 100 comprises an aerosol-generating device 200 and an aerosol-generating article 300.

The aerosol-generating device 200 comprises a housing 202 defining a cavity 204 for receiving a portion of the aerosol-generating article 300. In FIG. 1, the aerosol-generating article 300 is engaged with, or received in the cavity 204 of, the aerosol-generating device 200.

The device 200 comprises a power supply 206, a controller 208, and a substantially blade-shaped heating element 210. The heating element 210 comprises an electrically resistive track supported on a substrate. The controller 208 is connected to the power supply 206 and the heating element 210. The controller 208 controls a supply of current from the power supply 206 through the electrically resistive track of the heating element 210 to control heating of the heating element 210.

The device 200 comprises an identifier 212 comprising a light source, for example an infrared light emitting diode (IR LED) 214 and a light receiver, for example a photodiode 216.

The device 200 further comprises an air inlet 218 for allowing air to flow into the cavity 204, and a button 220 which allows a user to operate the device 200.

The aerosol-generating article 300 comprises an aerosol-forming substrate 302, a hollow tubular transfer element 304, a mouthpiece 306 arranged sequentially within an outer wrapper 308. The outer wrapper 308 comprises a taggant 310 having an identifiable spectroscopic signature. The taggant 310 is incorporated in the wrapper during manufacturing of the wrapper material.

The wrapper material in this example is manufactured by incorporating the taggant 310 in powder form in the wrapper paper material slurry before the slurry is formed into paper and dried. The taggant 310 is thermally and chemically stable at the temperature and conditions used during manufacture such that the taggant 310 functions as desired in the assembled article 300. Alternatively, the taggant 310 may be applied to the wrapper material in a solution by spraying, printing, painting or the like.

The use of the taggant 310 incorporated within the material of the wrapper prevents the taggant 310 from being removed from the wrapper after manufacture. In this way, the tamper resistance, and difficulty of counterfeiting, of the aerosol-generating article are improved.

The taggant 310 material can be selected to control the optical properties such that it can absorb a specific wavelength of light to enable identification, or emit light at a shifted wavelength as compared to a wavelength of light used to excite the taggant 310 to enable identification, or both. As used here, the term “identification” may refer to determining whether the article belongs to the first group of articles, or determining which, if any, sub-group of the first group the article belongs to.

FIG. 2 shows circuitry of the aerosol-generating system 100 of FIG. 1. Specifically, FIG. 2 shows the power supply 206 and the IR LED 214 of the identifier 212 shown in FIG. 1. FIG. 2 further shows a high-side switch 222, a low-side switch 224, and a chronometer 226 for protecting the IR LED 214, and a heater high-side switch 228, a heater low-side switch 230, and a heater chronometer 232 for protecting the heating element 210.

The high-side switch 222 is located between the power supply 206 and the IR LED 214, and is coupled to the chronometer 226. The high-side switch 222 is moveable between an open position and a closed position. In the open position, the high-side switch 222 breaks the circuit, or current flow path, between the power supply 206 and the IR LED 214. In the closed position, the high-side switch 222 completes the circuit, or current flow path, between the power supply 206 and the IR LED 214.

The low-side switch 224 is located between the IR LED 214 and ground, and is coupled to the chronometer 226. The low-side switch 224 is moveable between an open position and a closed position. In the open position, the low-side switch 224 breaks the circuit, or current flow path, between the IR LED 214 and ground. In the closed position, the low-side switch 224 completes the circuit, or current flow path, between the IR LED 214 and ground.

The heater high-side switch 228 is located between the power supply 206 and the heating element 210, and is coupled to the heater chronometer 232. The heater high-side switch 228 is moveable between an open position and a closed position. In the open position, the heater high-side switch 228 breaks the circuit, or current flow path, between the power supply 206 and the heating element 210. In the closed position, the heater high-side switch 228 completes the circuit, or current flow path, between the power supply 206 and the heating element 210.

The heater low-side switch 230 is located between the heating element 210 and ground, and is coupled to the heater chronometer 232. The heater low-side switch 230 is moveable between an open position and a closed position. In the open position, the heater low-side switch 230 breaks the circuit, or current flow path, between the heating element 210 and ground. In the closed position, the heater low-side switch 230 completes the circuit, or current flow path, between the heating element 210 and ground.

Enabling or closing a switch refers to moving the switch from the open position to the closed position. Disabling or opening a switch refers to moving the switch from the closed position to the open position.

For clarity, the controller 208 of the device 200 is not shown in FIG. 2. However, as would be understood by the skilled person after reading this disclosure, the controller 208 controls the supply of power from the power supply 206 to the IR LED 214 and the heating element 210, and interacts with the chronometers 226, 232 to control the enabling and disabling of the switches 222, 224, 228, 230. This is explained in more detail below.

FIG. 2 also shows an input 402 to the chronometer 226. This input 402 may be used to determine or estimate a current being supplied to the IR LED 214. FIG. 2 also shows an input 404 from the chronometer 226 to the high-side switch 222. This input 404 may be, for example, an instruction to open or close the high-side switch 222. FIG. 2 also shows an input 406 from the controller 208 to the chronometer 226 which, as explained in more detail below, causes the chronometer 226 to enable the high-side switch 222. FIG. 2 also shows an input 408 from the controller 208 to the low-side switch 224 which, as explained in more detail below, is used to enable the low-side switch 224.

Similarly, for the heating element 210, FIG. 2 shows an input 502 to the heater chronometer 232. This input 502 may be used to determine or estimate a current being supplied to the heating element 210. FIG. 2 also shows an input 504 from the heater chronometer 232 to the heater high-side switch 228. This input 504 may be, for example, an instruction to open or close the heater high-side switch 228. FIG. 2 also shows an input 506 from the controller 208 to the heater chronometer 232 which, as explained in more detail below, causes the heater chronometer 232 to enable the heater high-side switch 228. FIG. 2 also shows an input 508 from the controller 208 to the heater low-side switch 230 which, as explained in more detail below, is used to enable the heater low-side switch 230.

A method of operating the aerosol-generating system 100 shall now be described with reference to the flow diagram shown in FIG. 3.

To begin, the device 200 is in an idle state. The user may insert the article 300 in the cavity 204 of the device 200 whilst the device 200 is in the idle state. In the idle state, the device is operational, but not being used to generate an aerosol.

The user then presses the button 220 for more than 1 second, causing the device 200 to transition from the idle state to an active state.

The transition from the idle state to the active state may cause electrical perturbations like voltage fluctuations (over voltage, under voltage, and other voltage surges) dangerous for the electronics and more in particular for the IR LED 214 and the heating element 210 of the device 200.

Once the device 200 is in the active state, a stick recognition (SR) sequence, also known as an aerosol-generating article recognition sequence, is activated. An aerosol-generating article may be referred to as a stick.

The high-side switch 222 is then enabled. That is, the high-side switch 222 is closed so as to form a current flow path from the power supply 206 to the IR LED 214. Specifically, in this embodiment, the high-side switch 222 is enabled by the chronometer 226. The controller 208 activates the chronometer 226 with the input 406 and, in turn, the chronometer 226 automatically enables the high-side switch 222. The controller 208 then disconnects from the chronometer 226, leaving the chronometer 226 to function independently.

The IR LED 214 in this embodiment has a continuous forward current of 20 milliamperes, and a peak forward current of 1 ampere with a corresponding limiting time of between 10 microseconds and 1 millisecond.

Following enabling the high-side switch 222, the power supply 206 is enabled.

A period of time for stabilisation of the electronics is then allowed. This period is at least 5 milliseconds long.

The controller 208 then sends the input 408 to the low-side switch 224 to close the low-side switch 224. Once this happens, the input 402 provides the chronometer 226 with an indication that current is now being supplied to the IR LED 214 and the chronometer 226 starts a timer. Thus, in this embodiment, the timer starts as soon as a current supplied to the IR LED 214 exceeds a threshold of zero amperes. But, in other embodiments, the timer may be started only if a current greater than a non-zero threshold of current is supplied to the IR LED 214. The threshold of the chronometer can be set as desired. If the current supplied to the IR LED 214 falls to the threshold (i.e. falls back to zero amperes) before the timer reaches a predetermined time period of 5 milliseconds, the chronometer 226 is reset. This may happen if, for example, the controller 208 opens the low-side switch. If the current supplied to the IR LED 214 remains above the threshold of 0 amperes and the timer reaches the predetermined time period of 5 milliseconds, the chronometer 226 sends the input 404 to the high-side switch 222 to open the high-side switch 222. This stops current being supplied to the IR LED 214 and may help to protect the IR LED 214 from damage. The device 200 may then return to the idle state. The chronometer 226 is a hardware chronometer and sends the input 404 to the high-side switch 222 absent any instruction to the controller 208. Thus, even if the controller malfunctions, the IR LED 214 may be protected.

After closing the low-side switch 224, the controller 208 controls the power supply 206 to supply a relatively low current of around 20 milliamperes to the IR LED 214 for between 10 microseconds and 2 milliseconds. The current causes the IR LED 214 to emit infrared light onto the article 300. Some of this light is reflected off the article 300 and is received by the photodiode 216. This allows the identifier 212 of the device 200 to act as an article presence detector and determine that an article 300 is present (i.e. engaged with the device 200). The low-side switch 224 may be opened, for example by the controller 208, once the current has been sent to the IR LED for a sufficient length of time.

If no article were present, the device 200 would return to the idle state. However, since the article 300 was detected, a first determining step of determining whether or not the article 300 engaged with the device 200 belongs to a first group of articles is performed. This involves the controller 208 closing the low-side switch 224 again and controlling the power supply 206 to supply a relatively high current of around 1 ampere to the IR LED 214 for between 200 microseconds and 2 milliseconds. This causes the IR LED 214 to emit infrared light onto the article 300. The taggant 310 in the outer wrapper 308 absorbs a particular set of wavelengths of the light emitted by the IR LED 214, and reflects another particular set of wavelengths of the light emitted by the IR LED 214. The photodiode 216 receives the particular set of wavelengths reflected by the outer wrapper 308 and, based on the missing, or absorbed set of wavelengths, determines that the article 300 belongs to the first group of articles which are designed and optimised for use with the device 200. The low-side switch 224 may be opened, for example by the controller 208, once the current has been sent to the IR LED for a sufficient length of time.

As explained above with reference to the step of determining whether an article is engaged with the device, if the controller 208 malfunctions and the low-side switch 224 is not opened, then the chronometer 226 may open the high-side switch 222 if the current supplied to the IR LED 214 remains above the threshold of 0 amperes and the timer reaches the predetermined time period of 5 milliseconds.

If the first determining step determined that the article 300 did not belong to the first group of articles, the device 200 would return to the idle state. However, since the first determining step determined that the article 300 does belong to the first group of articles, the heater high-side switch 228 is then enabled. That is, the heater high-side switch 228 is closed so as to form a current flow path from the power supply 206 to the heating element 210. Specifically, in this embodiment, the heater high-side switch 228 is enabled by the heater chronometer 232. The controller 208 activates the heater chronometer 232 with the input 506 and, in turn, the heater chronometer 232 automatically enables the heater high-side switch 228. The controller 208 then disconnects from the heater chronometer 232, leaving the heater chronometer 232 to function independently.

Following enabling the heater high-side switch 228, the heating experience is started.

The controller 208 sends the input 508 to the heater low-side switch 230 to close the heater low-side switch 230 and form a current flow path from the IR LED 214 to ground. The input 502 provides the heater chronometer 232 with an indication of the current being supplied to the heating element 210 and, if a current greater than a threshold is supplied to the heating element 210, the heater chronometer 232 starts a timer. If the current supplied to the heating element 210 falls to or below the threshold before the timer reaches a predetermined time period, the heater chronometer 232 is reset. If the current supplied to the heating element 210 remains above the threshold and the timer reaches the predetermined time period, the heater chronometer 232 sends the input 504 to the heater high-side switch 228 to open the heater high-side switch 228. This stops current being supplied to the heating element 210 and may help to protect the heating element 210 from damage and the article 300 from being overheated. The device 200 may then return to the idle state. The heater chronometer 232 is a hardware chronometer and sends the input 504 to the heater high-side switch 228 absent any instruction to the controller 208. Thus, even if the controller 208 malfunctions, the heating element 210 may be protected.

Once the heater low-side switch 230 is closed, the controller 208 controls the power supply 206 to supply power to the heating element 210 and begin pre-heating. Pre-heating of the heating element 210 begins and the pre-heating check is performed at regular intervals. Each check involves measuring a temperature of the heating element 210 to determine whether the heating element 210 has reached a threshold temperature. If the temperature has not reached the threshold temperature, the pre-heating check is performed again after an interval. If the temperature has reached the threshold temperature, then the pre-heating of the heating element 210 is finished.

In this embodiment, finishing pre-heating triggers performance of a second determining step of determining whether or not the article 300 engaged with the device 200 belongs to the first group of articles. The second determining step is performed in the same way as the first determining step. Thus, the second determining step involves sending a relatively high current of around 1 ampere to be sent to the IR LED 214 for between 200 microseconds and 2 milliseconds. And, as for the first determining step, this causes the IR LED 214 to emit infrared light onto the article 300. The taggant 310 in the outer wrapper 308 absorbs a particular set of wavelengths of the light emitted by the IR LED 214, and reflects another particular set of wavelengths of the light emitted by the IR LED 214. The photodiode 216 receives the particular set of wavelengths reflected by the outer wrapper 308 and, based on the missing, or absorbed set of wavelengths, determines that the article 300 belongs to the first group of articles which are designed and optimised for use with the device 200.

If the second determining step determined that the article 300 did not belong to the first group of articles, the device 200 would return to the idle state. However, since the second determining step determined that the article 300 does belong to the first group of articles, the experience continues. Specifically, a main heating step is carried out.

During the main heating step, a user inhales on the article 300. This causes air to flow through the air inlet 218 and into the cavity 204. This inhalation is detected using a puff detection mechanism (not shown) of the device 200. The puff detection mechanism informs the controller 208 that a puff has been taken, and the controller 208 controls the power supply 206 to supply power to the heating element 210 accordingly. Specifically, more power is sent to the heating element 210 so as to heat the article 300 and release volatile compounds from the aerosol-forming substrate. The air flows through the substrate and entrains these compounds. The air and entrained compounds then flow through the tubular transfer element 304. The entrained compounds cool and condense so as to generate an aerosol. The aerosol is drawn through the mouthpiece 306 and into the mouth of the user. The user may then inhale the aerosol. The main heating step comprises further raising the temperature of the heating element 210 in response to each inhalation or puff on the article 300. The main heating step typically lasts around four minutes.

In this embodiment, the second determining step not only determines that the article 300 belongs to the first group of articles, but also determines a sub-group of the first group to which the article 300 belongs. Specifically, based on the light received by the photodiode 216, the identifier 212 determines the type of aerosol-forming substrate 302 present in the article 300. The main heating step is dependent on the sub-group of the first group to which the article 300 belongs, as determined by the second determining step. Specifically, the temperature to which the heating element 210 is heated in response to inhalations 300 is set based on the sub-group determined by the second determining step. Thus, in this embodiment, the main heating step is tailored to the type of aerosol-forming substrate 302 present in the article 300. The pre-heating step could equally have been dependent on the sub-group to which the article 300 belongs.

The heating experience then finishes and the power supply 206 stops supplying power to the heating element 210.

The heater high-side switch 228 is then disabled and the heater low-side switch 230 is disabled, if not already disabled.

The high-side switch 222 is then disabled and the low-side switch 224 is disabled, if not already disabled. However, these switches 222, 224 could be disabled at any point after the second determining step.

The power supply 206 is then disabled.

The device 200 then returns to the idle state.

At any time during the heating experience, the user may press the button 220 for more than 1 second to stop the heating experience and cause switches 222, 224, 228, 230 and the power supply 206 to be disabled, and the device 200 to return to the idle state.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. An aerosol-generating device configured to engage with and disengage from an aerosol-generating article, the aerosol-generating device comprising:
an identifier comprising a light source and being configured to determine one or both of whether the aerosol-generating article is engaged with the aerosol-generating device and whether the aerosol-generating article engaged with the aerosol-generating device belongs to a first group of articles;
a power supply configured to supply a current to the light source;
a switch moveable between a closed position, in which the power supply is able to supply a current to the light source, and an open position, in which the power supply is unable to supply a current to the light source; and
a chronometer coupled to the switch and being configured to move the switch from the closed position to the open position if the current supplied to the light source or an indication of the current supplied to the light source exceeds a threshold for longer than a predetermined time period.

17. The aerosol-generating device according to claim 16, wherein the chronometer is a hardware chronometer and is further configured to move the switch from the closed position to the open position absent an instruction to do so from any separate controller if the current supplied to the light source or the indication of the current supplied to the light source exceeds the threshold for longer than the predetermined time period.

18. The aerosol-generating device according to claim 16, further comprising a controller configured to control a supply of current from the power supply to the light source.

19. The aerosol-generating device according to claim 18, wherein the chronometer is a hardware chronometer and is further configured to move the switch from the closed position to the open position absent an instruction to do so from the controller if the current supplied to the light source or the indication of the current supplied to the light source exceeds the threshold for longer than the predetermined time period.

20. The aerosol-generating device according to claim 16, wherein the switch is a high-side switch and electrically connects the power supply to the light source.

21. The aerosol-generating device according to claim 16, wherein the switch is a low-side switch and electrically connects the light source to ground.

22. The aerosol-generating device according to claim 20, further comprising a second switch, which is a low-side switch and which electrically connects the light source to ground.

23. The aerosol-generating device according to claim 22,
wherein the chronometer receives the indication of the current being supplied to the light source, and
wherein the chronometer is further configured to move the switch from the closed position to the open position if the indication of the current supplied to the light source exceeds the threshold for longer than the predetermined time period.

24. The aerosol-generating device according to claim 16, wherein the identifier further comprises a light receiver configured to receive light reflected or emitted by the aerosol-generating article engaged with the aerosol-generating device and illuminated by light from the light source.

25. The aerosol-generating device according to claim 16, wherein the light source is a light emitting diode.

26. The aerosol-generating device according to claim 25, wherein the light source is an infrared light emitting diode.

27. The aerosol-generating device according to claim 16, wherein the predetermined time period is at least 1 microsecond.

28. The aerosol-generating device according to claim 16, wherein the predetermined time period is no more than 10 milliseconds.

29. The aerosol-generating device according to claim 16, wherein the threshold is zero amperes.

30. A method of operating an aerosol-generating device according to claim 16, the method comprising moving the switch from the closed position to the open position if a current supplied to the light source or an indication of a current supplied to the light source exceeds a threshold for longer than a predetermined time period.
